(19) United States
(12) Patent Application Publication
(10) Pub. No.: US 2016/0070016 A1
(43) Pub. Date: Mar. 10, 2016

(54) DOWNHOLE SENSOR, ULTRASONIC LEVEL SENSING ASSEMBLY, AND METHOD

(71) Applicants: Ke Wang, Houston, TX (US); Zhiyue Xu, Cypress, TX (US)

(72) Inventors: Ke Wang, Houston, TX (US); Zhiyue Xu, Cypress, TX (US)

(73) Assignee: Baker Hughes Incorporated, Houston, TX (US)

(21) Appl. No.: 14/479,898

(22) Filed: Sep. 8, 2014

(51) Int. Cl. G01V 1/52; E21B 47/04

(52) U.S. Cl. CPC G01V 1/52; E21B 47/042

(57) ABSTRACT

A downhole sensor including a body configured for attachment to a downhole pump. The body having a fluid receiving portion; and, an ultrasonic transducer supported by the body; wherein ultrasonic pulses transmitted by the ultrasonic transducer are directed towards the fluid receiving portion, and reflected waves receivable by the ultrasonic transducer are indicative of a liquid fluid level and type of fluid within the fluid receiving portion. A method of determining a liquid fluid level and a type of fluid adjacent a downhole pump.

### BACKGROUND

In the drilling and completion industry, the formation of boreholes for the purpose of production or injection of fluid is common. The boreholes are used for exploration or extraction of natural resources such as hydrocarbons, oil, gas, water, and alternatively for CO2 sequestration.

Downhole fluid level is an important parameter in the use of progressive cavity pumps (“PCPs”), electric submersible pumps (“ESPs”), and other artificial lift tools for oil and gas production. A successful well operation requires the balance between well production and equipment protection. Because not only has the optimized well production required a proper fluid level, the operation of downhole equipment also demands minimum fluid level to provide enough cooling and lubrication for equipment's performance and longevity. Most of the current available technologies, e.g. gas gun echometer and floater type level sensor, cannot provide continual measurement and perform poorly in foamy fluid situation.

The art would be receptive to alternative devices and methods for downhole fluid level sensing and detecting.

### BRIEF DESCRIPTION

A downhole sensor including a body configured for attachment to a downhole pump, the body having a fluid receiving portion; and, an ultrasonic transducer supported by the body; wherein ultrasonic pulses transmitted by the ultrasonic transducer are directed towards the fluid receiving portion, and reflected waves receivable by the ultrasonic transducer are indicative of a liquid fluid level and type of fluid within the fluid receiving portion.

An ultrasonic level sensing assembly includes at least one downhole sensor, each sensor including a body configured for attachment to a downhole pump, the body having a fluid receiving portion; and, an ultrasonic transducer supported by the body; a pulser/receiver; and, a diagnostic/control unit; wherein ultrasonic pulses transmitted by the ultrasonic transducer are directed towards the fluid receiving portion, and reflected waves receivable by the ultrasonic transducer are indicative of a liquid fluid level and type of fluid within the fluid receiving portion.

A method of determining a liquid fluid level and a type of fluid adjacent a downhole pump, the method includes attaching a downhole sensor to the downhole pump, the downhole sensor including a body having a fluid receiving portion, and an ultrasonic transducer supported by the body, a liquid fluid level within the fluid receiving portion being substantially same as a liquid fluid level exterior to the fluid receiving portion; pulsing the ultrasonic transducer towards the fluid receiving portion; receiving reflected waves at the ultrasonic transducer; and, determining the liquid fluid level and type of fluid adjacent the downhole pump based on the reflected waves at the ultrasonic transducer.

### BRIEF DESCRIPTION OF THE DRAWINGS

The following descriptions should not be considered limiting in any way. With reference to the accompanying drawings, like elements are numbered alike:

FIG. 1 depicts a system diagram of an exemplary embodiment of a downhole system having an exemplary embodiment of an ultrasonic sensor assembly associated with a pump of the downhole system;

FIG. 2 depicts a schematic cross-sectional view of the exemplary pump and ultrasonic sensor assembly of FIG. 1;

FIG. 3 depicts a perspective view of an exemplary embodiment of an ultrasonic level sensor for the ultrasonic sensor assembly of FIG. 2;

FIG. 4 depicts a side plan view of the exemplary ultrasonic level sensor of FIG. 3;

FIG. 5 depicts a graph of signals from three paths within the exemplary ultrasonic level sensor of FIG. 4;

FIG. 6 depicts a perspective view of an exemplary embodiment of a test set-up for the exemplary ultrasonic sensor assembly;

FIGS. 7A-7C depict graphs for signals at various fluid levels within the test set-up of FIG. 6;

FIG. 8 depicts a schematic cross-sectional view of the exemplary pump of FIG. 1 and another exemplary embodiment of an ultrasonic sensor assembly;

FIG. 9 depicts a schematic cross-sectional view of the exemplary ultrasonic sensor assembly of FIG. 8;

FIG. 10 depicts a schematic cross-sectional view of the exemplary ultrasonic sensor assembly of FIG. 9 with an exemplary embodiment of an auxiliary fluid receiving portion; and,

FIG. 11 depicts a schematic cross-sectional view of the exemplary pump of FIG. 1 and the exemplary ultrasonic sensor assembly of FIG. 9 with another exemplary embodiment of an auxiliary fluid receiving portion.

### DETAILED DESCRIPTION

A detailed description of one or more embodiments of the disclosed apparatus and method are presented herein by way of exemplification and not limitation with reference to the Figures.

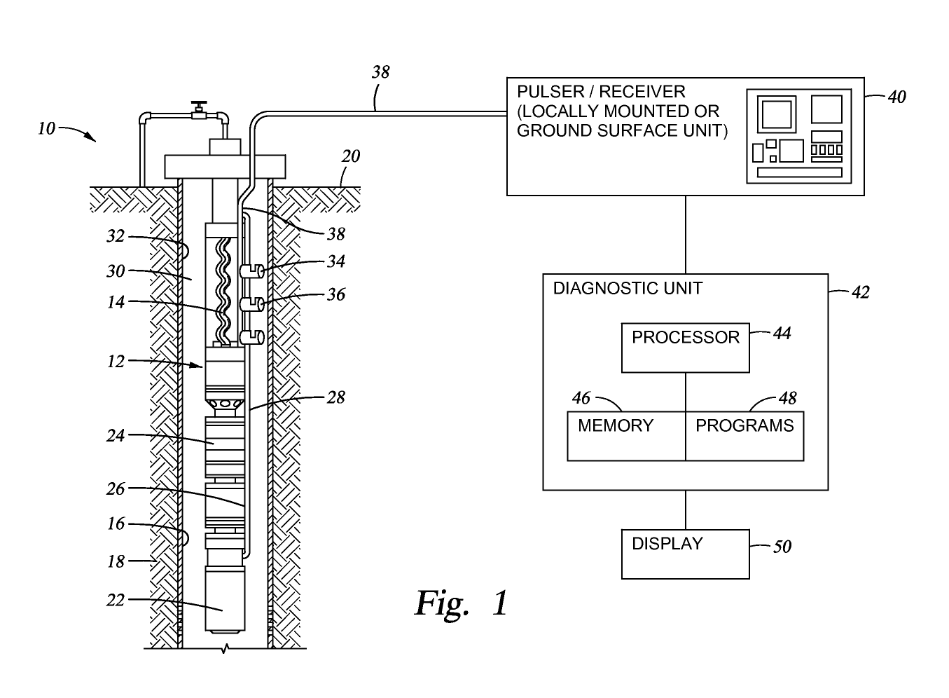

An exemplary embodiment of a downhole system 10 for fluid-type detecting and fluid level sensing is shown in FIG. 1. The downhole system 10 includes a pump system 12 having downhole pump 14, such as the illustrated progressive cavity pump (“PCP”), within a borehole 16 through a formation 18 that may be uncased (also known as open) or cased using a perforated casing for allowing the formations fluids to flow within the interior of the casing. The pump system 12 assists in the production of a variety of fluids from the borehole 16 to the surface 20 in an uphole direction. For the purposes of this description, it should be understood that a first feature may be said to be “downhole” of a second feature when the first feature is located further in the borehole 16 (such as from the surface 20). Likewise, the second feature may be said to be located “uphole” of the first feature when the second feature is not as far in the borehole 16 as the first feature (such as located closer to the surface 20). Even if the borehole 16 deviates horizontally, the path through the borehole 16 determines whether one feature is uphole or downhole the other feature. Other pumps and downhole pumps may also be included in the downhole system 10, such as, but not limited to, an electric submersible pump (“ESP”) and other artificial lifts. The pump system 12 further may further include a motor 22, seal section 24, gear reducing unit 26, power cable 28, and any other component known in downhole pump systems 12. It has been determined herein that having knowledge of the fluid level (of both wellbore liquids and gas) in the borehole 16 within an annulus 30 between the borehole wall 32 or casing and the pump 14, and having knowledge of the type of fluid in the annulus 30 surrounding the pump 14, would be of value to an operator. Types of fluid may include, but are not limited to, liquids such as oil and water, and gases such as air.

Thus, in addition to the pump system 12, the downhole system 10 further includes an ultrasonic level sensing assembly 34 that provides an indication of fluid level within the borehole 16 with respect to the pump 14 as well as an indication of the type of fluid that is within the borehole 16 surrounding the pump 14. The ultrasonic level sensing assembly 34 includes a body 36 that is attached or otherwise configured for connection to, or at least adjacent to, the pump 14. The ultrasonic level sensing assembly 34 is connected via a cable 38 to a pulser/receiver 40, which is locally mounted or a ground surface unit. The cable 38 may be part of the same cable 28 for the motor 22 of the pump 14. At the surface 20, or at a remote location, signals from the receiver 40 are sent to a diagnostic/control unit 42, exemplarily including a processor 44, memory 46, and programs 48. The diagnostic/control unit 42 can also control the pulser 40 to control the frequency of pulses emitted by the ultrasonic level sensing assembly 34. A display 50 is connected to the diagnostic/control unit 42 for viewing the signals processed by the diagnostic/control unit 42.

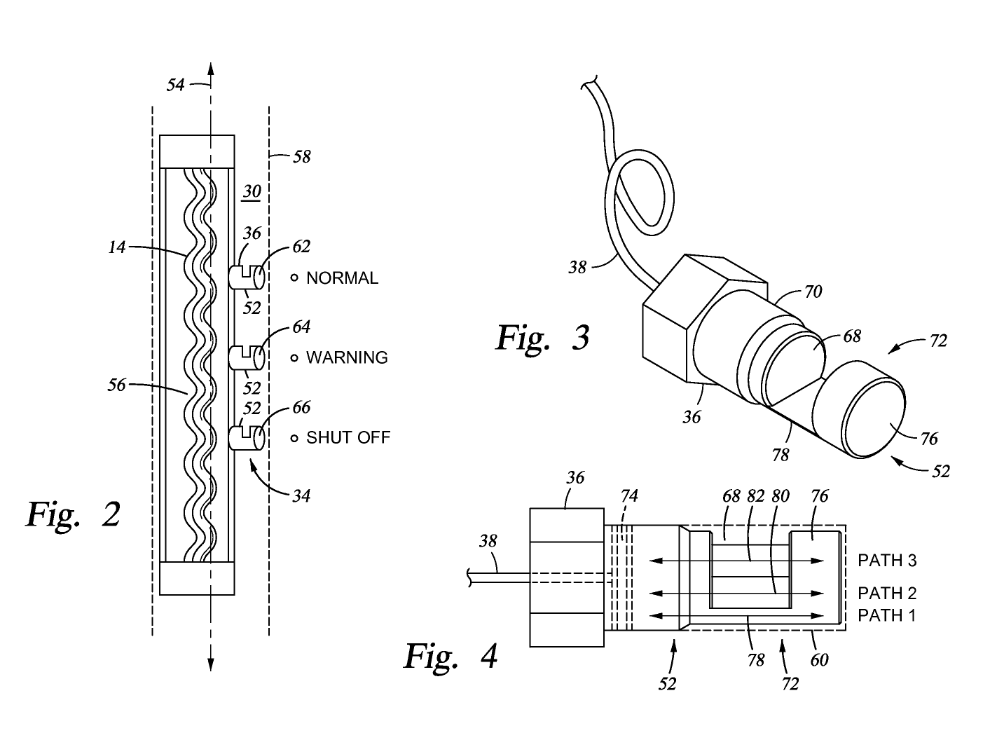

In the illustrated embodiment of FIG. 2, the ultrasonic level sensing assembly 34 is shown to include one or more ultrasonic level sensors 52 employed and positioned at different longitudinally spaced areas relative to a longitudinal axis 54 of the downhole pump 14. The bodies 36 of the sensors 52 are mounted on the housing 56 of pump 14 with minimum or no requirements to change the original design of the pump 14. It should be understood that the relative sizes between the pump 14 and the sensors 52 are exaggerated for clarity, and that the sensors 52 may be significantly smaller than the pump 14. That is, the attached sensors 52 do not increase the diameter of the pump 14 or only slightly increase the diameter. The level sensors 52 may utilize the same cable 28 as that of the pump 14 or sensor section for power, although may include its own cable 38. Also, while depicted exteriorly of the pump 14, the pump 14 may alternatively include pockets or indentations (not shown) in the pump housing 56 for mounting the sensors 52 therein. Further, the ultrasonic level sensing assembly 34 may include a screened or apertured housing 58 protecting all of the ultrasonic level sensors 52 therein, and/or the ultrasonic level sensors 52 may individually include screened or apertured housings 60 (FIG. 4) for protecting individual sensors 52. In addition to protecting the ultrasonic level sensors 52, the screened or apertured housings 58, 60 can assist in preventing debris and solid particulates from interfering with the sensor operations.

For applications to monitor downhole fluid level relative to the pump 14, a set of sensors 52 can provide level measurements at different locations along the pump 14. For example, three ultrasonic level sensors 52 are depicted at three longitudinally distinct areas of the pump 14. A first ultrasonic level sensor 62 is provided at an upholemost location of the ultrasonic level sensing assembly 34 relative to the pump 14. A second ultrasonic level sensor 64 is positioned longitudinally between the first ultrasonic level sensor 62 and a third ultrasonic level sensor 66. If fluid (in particular, liquid) is detected by the first, second, and third ultrasonic level sensors 62, 64, 66, this indicates a normal liquid fluid level relative to the pump 14. This information will assure an operator that the downhole system 10, and in particular the pump 14, has the proper liquid fluid level to function normally. While a borehole 16 may be filled with liquid to a proper liquid fluid level, the liquid may not be the type of liquid required for proper pump function, and therefore it is also a feature of the downhole sensors 52 to assess the type of fluid adjacent the pump, in addition to providing liquid fluid level information. If no liquid is detected by the first ultrasonic level sensor 62, but liquid is detected by the second and third ultrasonic level sensors 64, 66, an operator may be provided with a warning that the fluid level relative to the pump 14 is not at a normal level, and a more urgent warning may be provided if no liquid is detected by the first and second ultrasonic fluid level sensors 62, 64, but liquid is detected by the third fluid level sensor 66. Depending on the fluid level, appropriate investigations may be performed to determine issue and follow-up as needed. If no liquid is detected by the first, second, and third ultrasonic level sensors 62, 64, 66, the diagnostic/control unit 42 may be programmed to provide a signal to an operator to shut off the pump 14, or the pump 14 may be automatically stopped to prevent damage to the pump 14. The number of level sensors 52 and the spacing there between may be altered, as well as the response associated with each level sensor 52. For example, the responses may also include warnings and/or shutting off the pump 14 if it is determined that the liquids in which the pump 14 is immersed are not suitable for proper pump function or if the wellbore liquids are undesirable for production.

Turning now to FIGS. 3 and 4, an exemplary embodiment of the ultrasonic level sensor 52 is shown in more detail. The ultrasonic level sensor 52 includes a rugged design based on the characteristics of ultrasound propagating through different surrounding media. The ultrasonic level sensor 52 can provide both in situ and continuous fluid level monitoring for downhole pumps 14. Furthermore, the same sensors 52 can provide qualitative measurement on the fluid properties, such as density, of the fluid within the fluid receiving portion 68 of the sensors 52. The level sensors 52 may be designed for robustness for long-term fluid level monitoring, and advantageously the sensors 52 enable extra fluid information to be obtained using the same sensor 52.

The sensor 52 includes a body 36 supporting an ultrasonic transducer 70 and a wave guide 72. The size of the ultrasonic transducer 70 and wave guide 72 can be easily adjusted to fit different applications. The ultrasonic transducer 70 is capable of sending an ultrasound (pulse wave) as well as detecting the reflected sound (reflected wave) and converting the reflected wave to an electrical signal. To produce the ultrasound, a piezoelectric crystal 74 has an alternating current applied across it, which causes the piezoelectric crystal 74 to vibrate at high speed and produce an ultrasound (“the piezoelectric effect”). Reflected sounds hit the piezoelectric crystal 74 causing the mechanical energy produced from the sound vibrating the crystal 74 to be converted into electrical energy. A measurement of the time between when the sound was sent and received is indicative of the type of fluid within the wave guide 72. The wave guide 72 includes the fluid receiving portion 68, a reflection portion 76, and a reference portion 78. The reflection portion 76 of the wave guide 72 is attached to the ultrasonic transducer 70 by the reference portion 78. The space between the ultrasonic transducer 70 and the reflection portion 76 and uphole of the reference portion 78 is identified as the fluid receiving portion 68. Because the fluid receiving portion 68 is an open space, it is capable of accurately indicating a fluid level within the annulus 30 by not trapping any fluid therein. Thus, if the fluid level receiving portion 68 includes any side walls, they are screened or at least perforated at a lower portion thereof so that the fluid receiving portion 68 is incapable of holding a fluid therein.

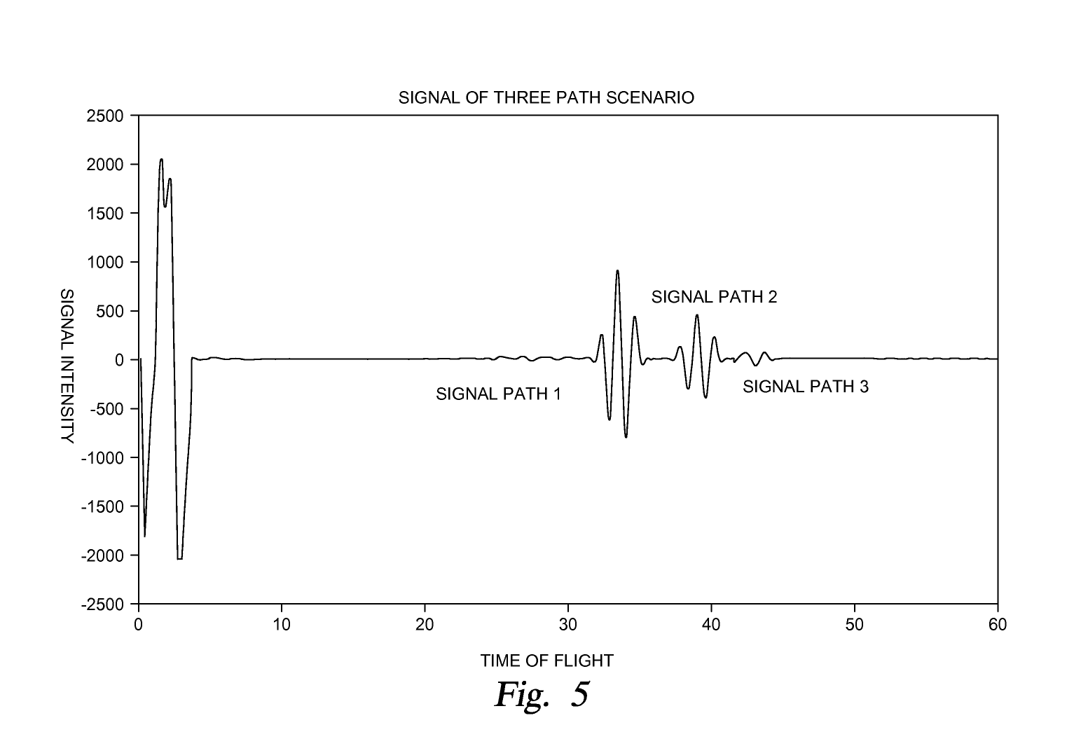

The diagnostic/control unit 42 of the ultrasonic sensing assembly 34 can control when and how often the ultrasonic transducer produces an ultrasound. During a measurement, the ultrasonic transducer 70 excites ultrasonic signal that propagates along the wave guide 72. Based on the design of wave guide 72, there are at least two propagating paths for the signal: one is through the reference portion 78 of the wave guide 72 (Path 1), and the other one is through the fluid receiving portion 68 (Path 2). Additional paths may be defined through the fluid receiving portion 68, such as Path 3. Identifying a third path may be helpful when more than one type of fluid is within the fluid receiving portion 68. For example, a layer of oil may be detectable on top of a layer of water. The travel time and intensity of the reflected ultrasonic signals through Path 2 (and Path 3) is a function of the fluid level (if there is even liquid within the fluid receiving section 68) and fluid type, e.g. gas, oil, water, or oil-water mixture. When the liquid fluid level doesn't reach the sensor, only one ultrasonic signal (a reference signal through the reference portion) is observed though Path 1. As the liquid fluid level rises and gradually fills the fluid receiving portion 68, the ultrasonic signal through Path 2 begins to appear and its intensity becomes stronger until the fluid receiving portion 68 is totally filled with liquid. In the exemplary design of the wave guide 72, the signal from Path 1 always provides a reference measurement, which ensures accurate level monitoring using the signal from Path 2, and Path 3. The material of the wave guide 72 does not change during use and therefore a constant signal is always detected through Path 1, regardless of liquid fluid level and type of fluid in which the pump is employed. Meanwhile, the signal speed (sound velocity) through Path 2 and Path 3 is a function of fluid type of the fluid that fills the open space of the fluid receiving portion, and generally signal speed varies with fluid density. Therefore the same sensors can be used to provide the information about the fluid type. An exemplary chart showing three signals read through the ultrasonic level sensor 52 is shown in FIG. 5, where the reference signal is labeled Path 1, the signal through a first fluid 80 within the fluid receiving portion 68 is labeled Path 2, and the signal through a second fluid 82 within the fluid receiving portion 68 is labeled Path 3. Because the signals through Path 2 and Path 3 are different, an operator will know that there are two different types of fluid 80, 82 within Paths 2 and 3 of the ultrasonic level sensor 52. Also, based on known values of ultrasonic sound velocity through various materials, an operator will further be able to identify the different materials that are within the Paths 2 and 3 of the ultrasonic level sensor 52.

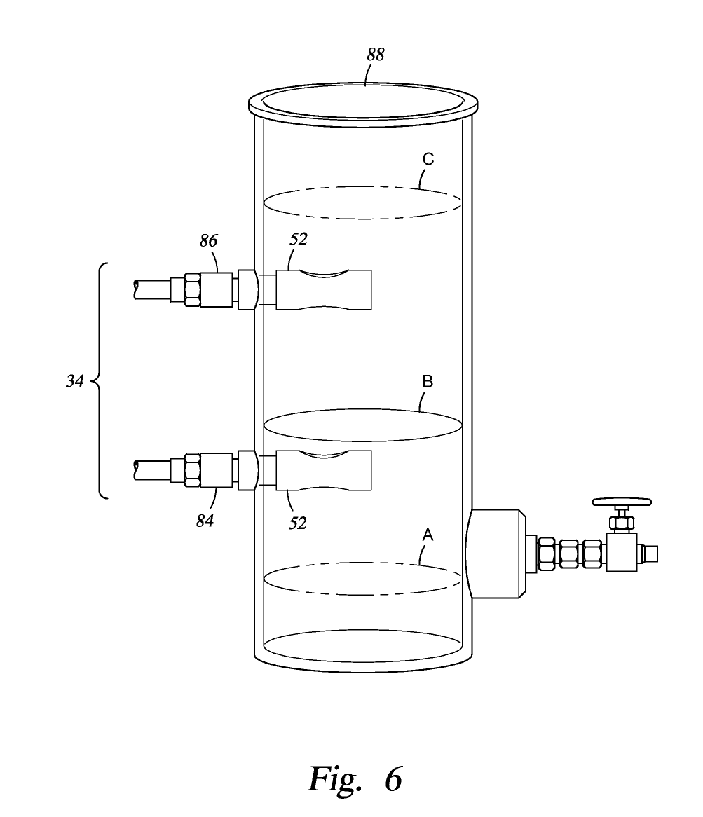

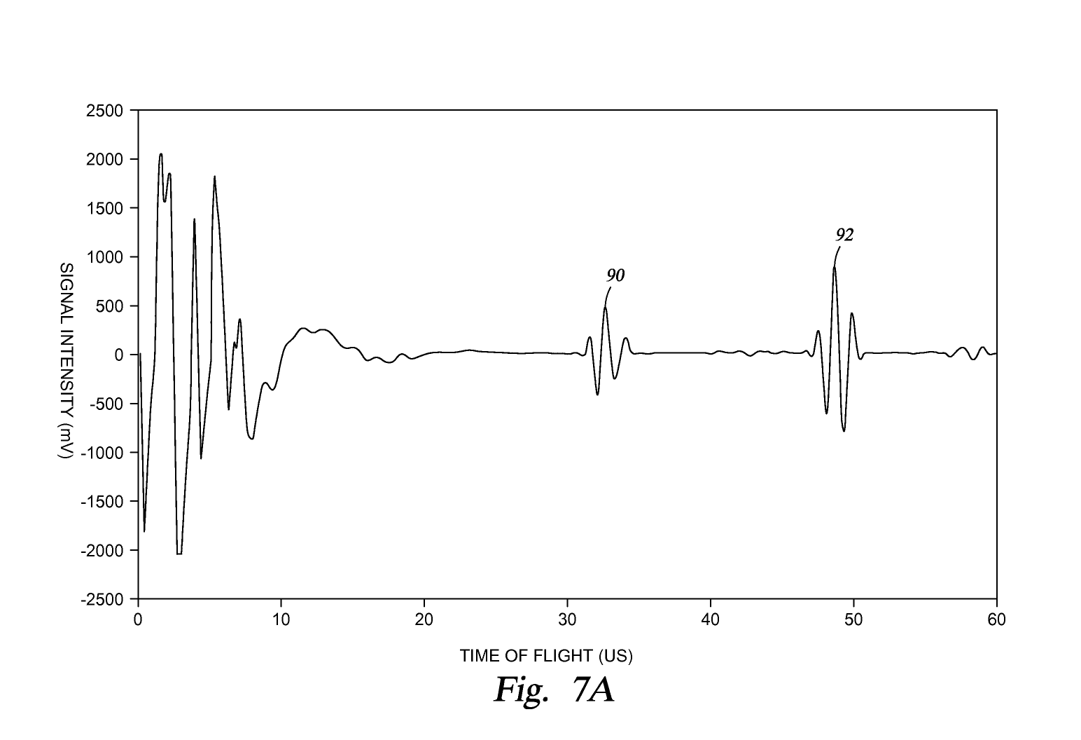

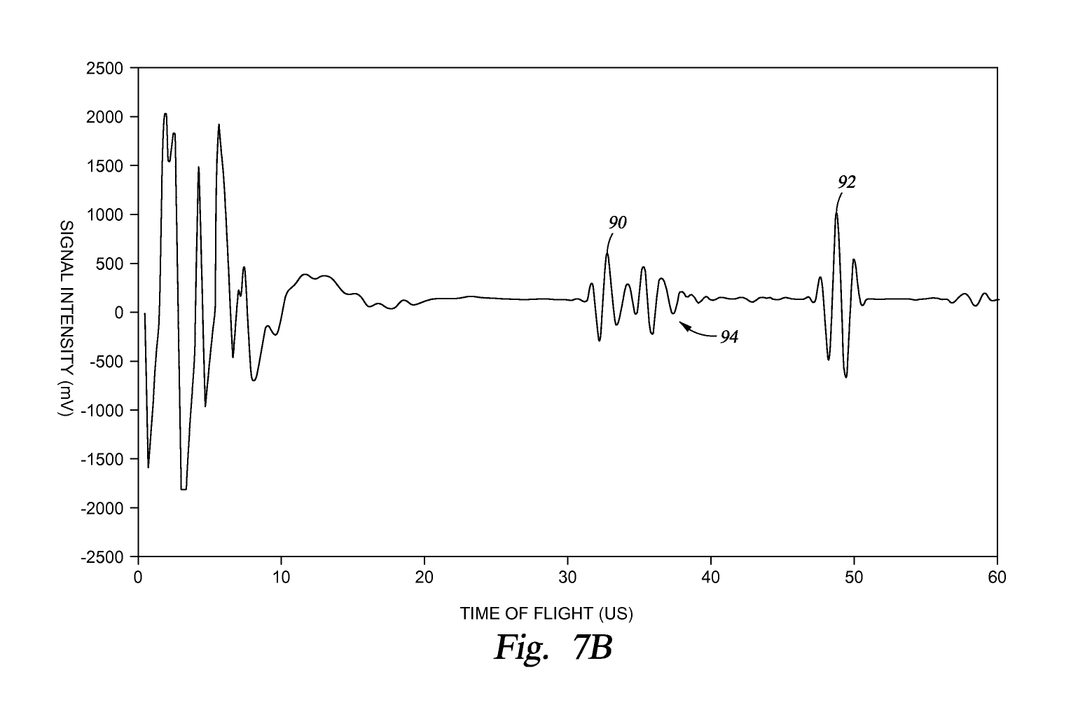

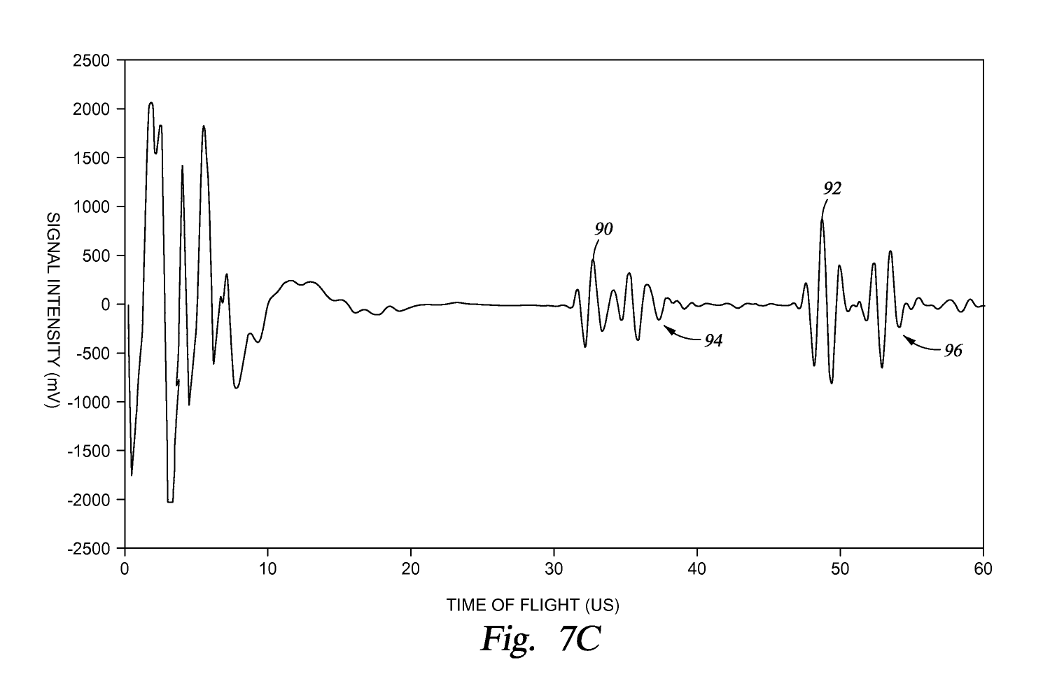

Turning to FIGS. 6 and 7A-7C, a test conducted to demonstrate the effect of fluid level on an exemplary ultrasonic level sensing assembly 34 having two sensors 52, where fluid level within an annulus 30 is demonstrated by changing liquid fluid levels within a flask 88. With reference to FIG. 7A, when the liquid fluid is below both sensors 52, where a first sensor 84 is positioned lower than a second sensor 86, such as at level “A” as noted in FIG. 6, only first and second reference signals 90, 92 are noted in the time of flight vs. signal intensity chart. With reference to FIG. 7B, when the liquid fluid level is above the first sensor 84, but below the second sensor 86, such as at level “B” as noted in FIG. 6, both reference signals 90, 92 are still noted in the chart, a first fluid-detecting signal 94 next to the first reference signal 90 appears, but no fluid-detecting signal next to the second reference signal 92 is shown. This would indicate to an operator that a liquid fluid level higher than the first sensor 84 but lower than the second sensor 86 is present. And, with reference to FIG. 7C, when the liquid fluid level is over both sensors 84, 86, such as at level “C” as noted in FIG. 6, both reference signals 90, 92 are still noted in the chart, the first fluid-detecting signal 94 next to the first reference signal 90 still appears, and an additional second fluid-detecting signal 96 next to the second reference signal 92 appears, indicative of liquid fluid at a level at least higher than the second sensor 86. The strength of the signals 94, 96 can further be used to identify the type of liquid fluid sensed by the sensors 84, 86, by comparing signal strength with known values (or a range of values) of ultrasound propagating through various fluids.

Because the ultrasonic transducer body 36 and wave guide 72 are made of metal (such as Stainless Steel 316), the proposed level sensor 52 has a broad range with respect to working environments. The screened or apertured housing 58, 60 that surrounds the ultrasonic level sensing assembly 34 and/or the individual ultrasonic level sensors 52 allows for fluids to enter in an uninterrupted fashion to the fluid receiving portion 68 of the waveguide 72, however the housings 58, 60 prohibit gravel, sand, and other particulates from lodging themselves into the fluid receiving portion 68, as such particulates may reflect the propagated ultrasonic waves and provide incorrect signal readings of the fluids in the vicinity of the pump 14.

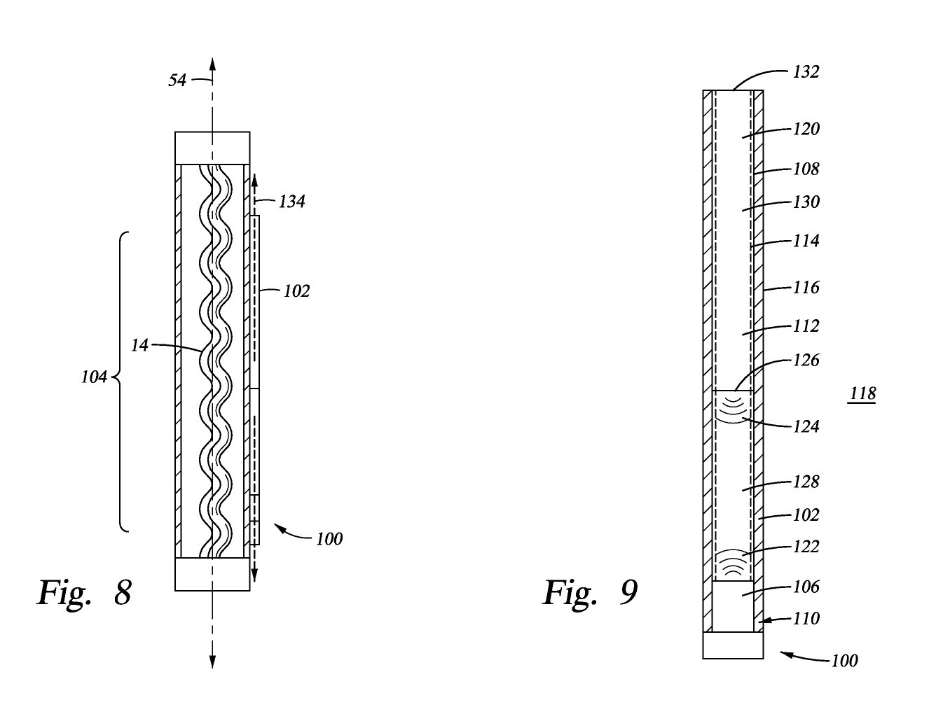

Turning now to FIGS. 8 and 9, in another exemplary embodiment of an ultrasonic level sensing assembly 100, the assembly 100 also has an operating property based on the characteristics of ultrasound propagating through different paths as liquid fluid level varies. The ultrasonic level sensor 102 used in the ultrasonic level sensing assembly 100 can provide both in situ and continuous liquid fluid level monitoring for a downhole pump 14, such as, but not limited to, PCPs, ESPs, and other artificial lift tools. The ultrasonic level sensing assembly 100 also includes a rugged design for robustness of the device for long-term and continuous liquid fluid level monitoring. Further, the ultrasonic level sensing assembly 100 also has the ability to obtain extra fluid information using the same sensor 102. The dimensions of the ultrasonic level sensor 102 are adjustable for different applications.

As shown in FIG. 8, the ultrasonic level sensing assembly 100 includes a single ultrasonic level sensor 102 which is capable of providing liquid fluid level information and fluid type information throughout the entire longitudinal length of the annulus 30 within a selected area 104 of the annulus 30. While only one ultrasonic level sensing assembly 100 is necessary, an operator may choose to attach a second ultrasonic level sensing assembly 100 (not shown) to another radial location of the downhole pump 14 for redundancy.

As more clearly shown in FIG. 9, the ultrasonic level sensor 102 includes a body 110 supporting an ultrasonic transducer 106 and having a fluid receiving portion 112. The body 110 includes a transducer housing 108, which forms the fluid receiving portion 112. The fluid receiving portion 112 has a longitudinal axis 134 that may be substantially parallel to the longitudinal axis 54 of the pump 14. As with the fluid receiving portion 68 of the ultrasonic sensor 52, the fluid receiving portion 112 is incapable of retaining fluid therein, and is dependent upon liquid fluid level exterior of the transducer housing 108 to fill the fluid receiving portion 112 with liquid. That is, as the liquid fluid level exterior 118 of the transducer housing 108 changes, so does the liquid fluid level within the interior 120 of the transducer housing 108 such that the liquid fluid level within the interior 120 of the transducer housing 108 is indicative of the liquid fluid level exterior 118 of the transducer housing 108. The ultrasonic transducer 106 excites ultrasonic signal that probes the liquid fluid level change continuously inside the transducer housing 108, and is capable of working at high pressures, such as up to 20,000 psi or more, and up to high temperatures, such as up to 175° C. (283° F.) or higher. The ultrasonic transducer 106 is hermetically sealed at the bottom of the transducer housing 108. As noted above, the transducer housing 108 provides a controlled environment for accurate liquid fluid level measurement. In an exemplary embodiment of the transducer housing 108, the transducer housing 108 includes a multi-layer structure, such as the illustrated two layer structure. An inner layer 114 of the transducer housing 108 may be made of stainless steel with small holes (an apertured tubular) along the housing 108 to allow fluid to enter the interior 120 of the transducer housing 108. An outer layer 116 of the transducer housing 108 may be a wrapping screen, such as one made of porous sponge and fine metal screen, to prevent small formation debris and bubbles to enter the interior 120 of the transducer housing 108. The housings 58, 60 for the ultrasonic level sensing assembly 34 may use a similar multi-layered structure with inner and outer layers 114, 116. The size and length of the ultrasonic transducer 106 and transducer housing 108 are adjustable to fit different applications. The ultrasonic level sensing assembly 100 is attachable to the downhole pump 14, such as by welding or using a securement device, such as, but not limited to clips, clamps, straps, or the like. Alternatively, the downhole pump 14 may be configured with a housing specially designed to incorporate the ultrasonic level sensing assembly 100 thereon.

During a measurement, the ultrasonic transducer 106 excites ultrasonic signal that propagates along the fluid volume inside the transducer housing 108, as indicated by pulse waves 122. The signal is reflected, as depicted by reflected waves 124, at the interface 126 between the wellbore fluid 128 and air 130 inside the housing 108. If wellbore liquid fluid 128 completely fills the transducer housing 108, then the signal will be reflected at the reflection portion 132 of the transducer housing 108. The travel time of the signal is proportional to the liquid fluid level. As the liquid fluid level rises gradually, the signal takes a correspondingly longer time to travel back to the ultrasonic transducer 106 in a linear fashion. Furthermore, since the signal is excited and probes the liquid fluid level from below (downhole) the liquid fluid rather than above the liquid fluid, the ultrasonic level sensor 102 is more immune to the effect of a possible foamy layer in the borehole 16, which usually stays right above the real liquid fluid level.

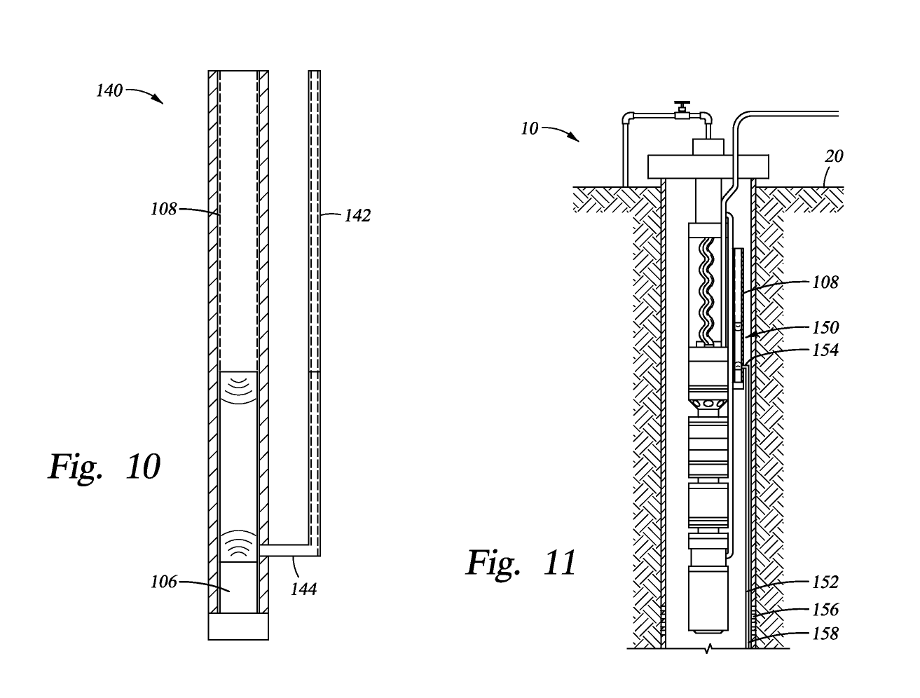

For the applications to monitor the downhole fluid level for downhole pumps 14, PCPs, ESPs, and artificial lift tools, the ultrasonic level sensing assembly 100 can be mounted on the housing of the tools with minimum requirements to change the original design. The same ultrasonic level sensor 102 can also provide qualitative measurement on the fluid properties, such as density, passing through the sensor. As with the ultrasonic level sensor 52, the speed in which the reflected signal returns to the ultrasonic transducer 106 will provide an indication as to the type of fluid contained within the fluid receiving portion, such as oil or water. To further avoid the interference with gas bubbles, changes can be made to the housing 108 as shown in FIGS. 10 and 11. With reference to FIG. 10, a “U” shape transducer housing 140 includes the housing 108 with an auxiliary fluid receiving portion 142 having a connecting portion 144 fluidically connected to the transducer housing 108, such as at a location between the ultrasonic transducer 106 and the fluid receiving portion 112 or along the fluid receiving portion 112. The auxiliary fluid receiving portion 142 may extend substantially parallel with the transducer housing 108, and may also include a porous and/or aperture structure, such as that of, or similar to, the multi-layer structure 114, 116 shown in FIG. 9. With reference to FIG. 11, a dip tube type transducer housing 150 includes the housing 108 with an auxiliary fluid receiving portion 152 having a connecting portion 154 fluidically connected to the transducer housing 108, such as at a location between the ultrasonic transducer 106 and the fluid receiving portion 112 or along the fluid receiving portion 112. Different from the embodiment shown in FIG. 10, the auxiliary fluid receiving portion 152 includes an imperforate or solid-walled structure, where the bottom opening 158 into the auxiliary fluid receiving portion 152 is lower than casing perforations 156. In addition, with further reference to FIGS. 8 and 9, the ultrasonic level sensor 102 can utilize the same cable 28 as that of the downhole pump 14 or sensor section for power supply and signal transmission, or use its own cable 38. The ultrasonic level sensing assembly 100 may further incorporate a similar surface set-up as is shown in FIG. 1 for monitoring and control.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A downhole sensor comprising:
a body configured for attachment to a downhole pump, the body having a fluid receiving portion; and,
an ultrasonic transducer supported by the body;
wherein ultrasonic pulses transmitted by the ultrasonic transducer are directed towards the fluid receiving portion, and reflected waves receivable by the ultrasonic transducer are indicative of a liquid fluid level and type of fluid within the fluid receiving portion.

2. The downhole sensor of claim 1, wherein a liquid fluid level within the fluid receiving portion is substantially same as a liquid fluid level exterior to the fluid receiving portion.

3. The downhole sensor of claim 1, further comprising a housing configured to allow fluid entry into and exit from the fluid receiving portion, and configured to prevent particulates from entering the fluid-receiving portion.

4. The downhole sensor of claim 3, wherein the housing is perforated.

5. The downhole sensor of claim 3, wherein the housing is a multi-layer structure including an inner apertured tubular and an outer wrapping screen.

6. The downhole sensor of claim 1, wherein the body includes a wave guide, the wave guide including the fluid receiving portion, a reference portion, and a reflection portion, wherein the fluid receiving portion and the reference portion are disposed between the ultrasonic transducer and the reflection portion.

7. The downhole sensor of claim 6, wherein the reference portion is a solid material and the fluid receiving portion is an open space.

8. The downhole sensor of claim 1, further comprising an auxiliary fluid receiving portion having a connecting portion fluidically connected to the body.

9. The downhole sensor of claim 1, wherein the ultrasonic transducer is positioned downhole of the fluid receiving portion when the body is attached to the downhole pump.

10. The downhole sensor of claim 9, wherein the body includes a transducer housing, the transducer housing having a longitudinal axis substantially parallel with a longitudinal axis of the downhole pump.

11. An ultrasonic level sensing assembly comprising:
at least one downhole sensor, each sensor comprising:
a body configured for attachment to a downhole pump, the body having a fluid receiving portion; and,
an ultrasonic transducer supported by the body;
a pulser/receiver; and,
a diagnostic/control unit;
wherein ultrasonic pulses transmitted by the ultrasonic transducer are directed towards the fluid receiving portion, and reflected waves receivable by the ultrasonic transducer are indicative of a liquid fluid level and type of fluid within the fluid receiving portion.

12. The ultrasonic level sensing assembly of claim 11, further comprising a plurality of the at least one downhole sensor, wherein each downhole sensor is configured for attachment at a different longitudinal location of the downhole pump.

13. The ultrasonic level sensing assembly of claim 12, wherein the body of each downhole sensor includes a wave guide, the wave guide including the fluid receiving portion, a reference portion downhole of the fluid receiving portion, and a reflection portion, wherein the fluid receiving portion and the reference portion are disposed between the ultrasonic transducer and the reflection portion.

14. The ultrasonic level sensing assembly of claim 11, further comprising a housing including apertures configured to allow fluid entry into and exit from the fluid receiving portion of the at least one downhole sensor, and configured to prevent particulates from entering the fluid receiving portion of the at least one downhole sensor.

15. A downhole system comprising the ultrasonic level sensing assembly of claim 11, the downhole system further comprising the downhole pump, the downhole pump configured for insertion in a borehole, and the at least one downhole sensor attached to the downhole pump.

16. The downhole system of claim 15, further comprising a power and transmission cable shared by the downhole pump and the ultrasonic level sensing assembly.

17. A method of determining a liquid fluid level and a type of fluid adjacent a downhole pump, the method comprising:
attaching a downhole sensor to the downhole pump, the downhole sensor including a body having a fluid receiving portion, and an ultrasonic transducer supported by the body, a liquid fluid level within the fluid receiving portion being substantially same as a liquid fluid level exterior to the fluid receiving portion;
pulsing the ultrasonic transducer towards the fluid receiving portion;
receiving reflected waves at the ultrasonic transducer; and,
determining the liquid fluid level and type of fluid adjacent the downhole pump based on the reflected waves at the ultrasonic transducer.

18. The method of claim 17, wherein the body further comprises a reflection portion, the fluid receiving portion disposed between the reflection portion and the ultrasonic transducer.

19. The method of claim 17, further comprising pulsing the ultrasonic transducer towards a reference portion of the body, and comparing a reference signal transmitted through the reference portion to the reflected waves passed through the fluid receiving portion.

20. The method of claim 17, wherein attaching a downhole sensor to the downhole pump includes attaching a plurality of the downhole sensors at different longitudinal locations along the downhole pump, and sending a warning signal if a liquid fluid level relative to the downhole pump is below one of the plurality of the downhole sensors.

21. The method of claim 17, wherein a longitudinal axis of the fluid receiving portion extends substantially parallel with a longitudinal axis of the downhole pump, and wherein determining the liquid fluid level includes measuring the liquid fluid level at any longitudinal location along the fluid receiving portion.

22. The method of claim 17, wherein determining the type of fluid adjacent the downhole pump includes determining a plurality of types of fluid adjacent the downhole pump.
